(19) United States
(12) Patent Application Publication
(10) Pub. No.: US 2025/0364624 A1
(43) Pub. Date: Nov. 27, 2025

(54) Battery Pack

(71) Applicant: Robert Bosch GmbH, Stuttgart (DE)

(72) Inventor: Florian Kneer, Duernau (DE)

(21) Appl. No.: 19/214,767

(22) Filed: May 21, 2025

(30) Foreign Application Priority Data
May 22, 2024 (DE) 10 2024 204 703.1

(51) Int. Cl. H01M 10/653; H01M 50/503

(52) U.S. Cl. CPC H01M 10/653; H01M 50/503; H01M 2220/30

(57) ABSTRACT

A battery pack, in particular to an exchangeable battery pack includes at least one housing for receiving at least one battery cell. The housing includes at least one housing portion with a cell connector configured to electrically connect the battery cell to a first thermal conductive element in thermal contact with the battery cell. The battery pack includes a second thermal conductive element. The thermal conductive elements are arranged on different sides of the housing and the second thermal conductive element is connected to the first thermal conductive element.

This application claims priority under 35 U.S.C. § 119 to patent application no. DE 10 2024 204 703.1, filed on May 22, 2024 in Germany, the disclosure of which is incorporated herein by reference in its entirety.

### BACKGROUND

DE 10 2016 203 424 A1 describes a battery pack with a thermally conductive insert.

### SUMMARY

The disclosure relates to a battery pack, in particular to an exchangeable battery pack comprising at least one housing for receiving at least one battery cell, wherein the housing comprises at least one housing portion with a cell connector configured to electrically connect the battery cell to a first thermal conductive element in thermal contact with the battery cell. It is proposed that the battery pack comprises a second thermal conductive element, wherein the thermal conductive elements are arranged on different sides of the housing and the second thermal conductive element is connected to the first thermal conductive element. Advantageously, the heat generated during operation of the battery pack can be better dissipated as a result.

The battery pack is in particular part of a system consisting of the battery pack and a consumer, wherein the consumer is powered via the battery pack during operation. The battery pack is in particular configured as a hand-held power tool battery pack. Preferably, the battery pack is configured as an exchangeable battery pack, which is preferably detachable and exchangeable by the user without tools. The battery pack is in particular designed to be connectable to a charging apparatus for charging the battery pack. Alternatively, the electrical consumer may also be configured as a way of transportation, for example an electric bicycle, as a domestic device, for example a vacuum cleaner, as a garden appliance, for example a hedge trimmer, or as a measuring device, wherein this list is not exhaustive.

The housing is preferably at least partially configured as an outer housing. At least one battery cell is housed in the housing of the battery pack. The battery pack, in particular the housing of the battery pack, can be detachably connected to the consumer and/or a charging device via a mechanical interface. The housing of the battery pack may comprise one or more housing portions. The battery pack may comprise a cell holder that is configured to receive and/or mount the battery cells in the housing. The cell holder may preferably comprise individual cell receptacles that are each configured to receive a single battery cell. Preferably, the cell holder is configured as one of the housing portions. The housing portions are connected to each other in a frictional, interlocking, and/or bonded manner. The cell holder is preferably made of a plastic, in particular a thermoplastic. The cell holder may partially form the outer housing of the battery pack. The cell holder is preferably designed in an integral or one-piece design. In the context of the present application, the term “one-piece” is understood to mean a component that is designed to be made of one piece and not made of multiple components connected to one another in a bonded, and/or frictional, and/or interlocking manner. Accordingly, a one-piece component consists of a single material. In the context of the present application, the term “integral” is in particular understood to mean an integral components, or multiple components, connected to one another in a bonded manner, e.g. via 2K injection molding. Alternatively, it is also conceivable that the cell holder be designed in multiple parts, wherein the different parts are connected to each other in a frictional and/or interlocking manner.

The battery pack preferably has a mechanical interface corresponding to the mechanical interface of the consumer. The battery pack can be connected to the consumer in a frictional and/or interlocking manner via the mechanical interfaces. Advantageously, the mechanical interface of the battery pack comprises at least one actuating element, via which the connection of the battery pack to the consumer and/or the charging device is detachable. The actuating element can, e.g., be designed as a button, a lever, or a pushbutton. In addition, the mechanical interface of the battery pack includes in particular a locking element for locking the battery pack with the consumer. The locking element is preferably mounted in a linearly and/or rotationally movable manner in the housing of the battery pack. The locking element is preferably mechanically coupled to the actuating element, so that a movement of the actuating element can be directly transmitted to the locking element.

The battery pack further comprises at least one electrical interface which corresponds to the electrical interface of the consumer and via which the battery pack is electrically connectable to the consumer and/or the charging device. The battery pack can, e.g., be charged and/or discharged via the electrical connection. Alternatively or additionally, it is also conceivable that information be communicable via the electrical interface. The electrical interface is preferably designed as a contact interface, where the electrical connection occurs via a physical contact of at least two conductive components. The electrical interface preferably comprises at least two electrical contact elements. In particular, one of the electrical contact elements is designed as a positive contact, and the other electrical contact element is designed as a negative contact. The electrical interface can further comprise at least one additional contact designed to transmit additional information to the consumer and/or the charging apparatus. Alternatively or additionally, the electrical interface can comprise a secondary charging coil element for inductive charging. Furthermore, the at least one battery cell, which can be electrically connected to the consumer via the electrical contact device, is arranged in the housing of the exchangeable battery pack.

A battery cell can be designed as a galvanic cell which has a structure in which one cell pole comes to lie at one end and a further cell pole comes to lie at an opposite end. In particular, the energy storage cell has a positive cell pole on one end face and a negative cell pole on the opposite end face. Preferably, the battery cells are designed as NiCd or NiMh, particularly preferably as lithium-based battery cells or Li-ion battery cells. The battery voltage of the battery pack is typically a multiple of the voltage of a single battery cell and results from the circuit (parallel or serial) of the battery cells. In common battery cells with a cell voltage of 3.6 V, voltage classes of, by way of example, 3.6 V, 7.2 V, 10, 8 V, 14.4 V, 18 V, 36 V, 54 V, 108 V, etc., are therefore produced. A battery cell is preferably designed as an at least substantially cylindrical round cell, wherein the cell poles are arranged at the ends of the cylindrical shape.

The cell connector is configured to electrically connect the battery cells to one another and/or to an electronic unit and/or to an electrical contact element. The cell connector is preferably made of a metallic material, in particular steel, aluminum, copper or an alloy comprising one of these metals. The cell connector may be connected to the battery cells in a friction-locking or a material-locking manner, for example via pressing, welding or soldering. The cell connector is preferably directly abutting a cell pole of the battery cell to be connected.

The first and/or the second thermal conductive element may be made of a metallic material and/or a plastic. The first and second thermal conductive elements may be made of the same material or different materials. The thermal conductive elements are preferably connected to each other via direct contact, such that the first thermal conductive element abuts the second thermal conductive element or the two thermal conductive elements are connected to each other in a one-piece or integral manner. Preferably, the thermal conductive elements are elastically configured, such that, in the assembled state, they are at least partially deformed. Advantageously, tolerances can thereby be balanced out, in particular by compensation for both internal and external forces, for example internal thermal expansion and external impacts.

Furthermore, it is proposed that the at least one housing portion comprises a recess, wherein the first thermal conductive elements and/or the second thermal conductive element is arranged in the recess. Advantageously, this can improve the heat dissipation outwards. Preferably, the recess is substantially completely filled with the first and/or the second thermal conductive element.

Furthermore, it is proposed that the first thermal conductive element and the second thermal conductive element are formed as one piece. In particular, the first thermal conductive element and the second thermal conductive element are made of a plastic, in particular a thermoplastic polymer, preferably a thermal conductive thermoplastic elastomer (TPE). In particular, the TPE has a thermal conductivity in at least one axis of at least 1.5 W/m*K, preferably at least 3.0 W/m*K, more preferably at least 10 W/m*K. Alternatively, it is also conceivable that the thermoplastic elastomer has a thermal conductivity of at least 0.2 W/m*K to at most 10 W/m*K, preferably at least 0.5 W/m*K to at most 3 W/m*K.

In addition, it is proposed that the housing portion is at least partially over-molded with the first thermal conductive element and/or the second thermal conductive element. Advantageously, an integrated component can thereby be provided with an optimum heat dissipation.

Furthermore, it is proposed that the first thermal conductive element abuts directly against the cell connector. Alternatively, it is also conceivable that a further intermediate layer, by way of example a dampening mat, an electrical insulator or an adhesive tape, in particular a Kapton adhesive tape, is arranged between the cell connector and the first thermal conductive element.

It is further proposed that the first thermal conductive element substantially completely covers an inner side of the housing portion. This can be advantageous for thermal characteristics. In particular, the heat distribution and the heat spreading are further optimized.

In addition, it is proposed that the second thermal conductive element has an area formed substantially equal to or smaller than an area of the first thermal conductive element. This has the advantage of further optimizing heat dissipation. However, it would also be contemplated that the area of the second thermal conductive element will be larger. It is also contemplated that the second thermal conductive element is configured thicker than the first thermal conductive element, which advantageously improves the dampening properties of the second thermal conductive element.

### BRIEF DESCRIPTION OF THE DRAWINGS

Further advantages follow from the description of the drawings below. The drawings, the description, and the claims contain numerous features in combination. A person skilled in the art will appropriately also consider the features individually and combine them into additional advantageous combinations.

The figures show:

FIG. 1 a schematic side view of a consumer with a battery pack;

FIG. 2 a perspective view of the battery pack of FIG. 1;

FIG. 3 a perspective cross-section of the battery pack of FIG. 2;

FIG. 4 a perspective view of a housing portion with a thermal conductive element.

### DETAILED DESCRIPTION

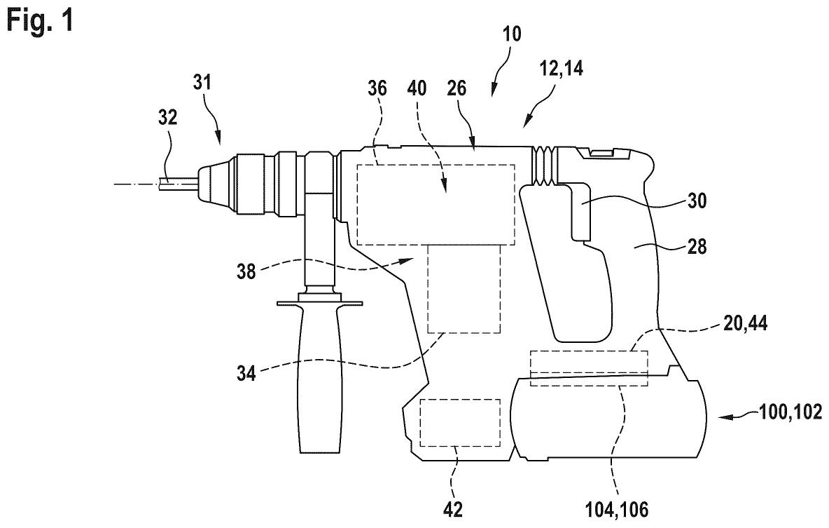

In FIG. 1, a side view of a system 10 consisting of an example electrical consumer 14 configured as a hand-held power tool 12 and a battery pack 100 are shown as an example in the form of a hand-held power tool battery pack 102. The hand-held power tool 12 is thus configured as a cordless hand-held power tool and is powered in operation via the battery pack 100. The hand-held power tool 12 and the battery pack 100 each have a mechanical interface 20, 104 via which the two components of the system 10 are detachably connected to each other. The battery pack 100 is thus detachable or interchangeable and can be replaced by the same or similar exchangeable battery pack. The hand-held power tool 12 is configured as a drill hammer. The mechanical interface 20 of the battery pack 100 is also configured to be detachably connectable to a charging device that is not shown.

The hand-held power tool 12 comprises a housing 26, at the rear end of which a handle 28 is arranged with an operation switch 30 for switching the hand-held power tool 12 on and off. A tool receptacle 31 is arranged at the front end of the housing 26 of the hand-held power tool 12 and is provided for receiving an insertion tool 32. A drive unit 38 comprising an electric motor 34 and a gearbox 36 is arranged between the handle 28 and the tool holder 31. The gearbox 36 comprises a percussion unit 40 and is arranged above the electric motor 34. The percussion unit 40 comprises a pneumatic percussion mechanism. Below the electric motor 34, an electronic unit 42 is arranged, via which the hand-held power tool 12 can be regulated or controlled. The battery pack 100 is arranged below the handle 28 and adjacent to the electronic unit 42.

The battery pack 100 and the consumer 14 each have a corresponding electrical interface 44, 106 via which the battery pack 100 is electrically connectable to the consumer 14, in particular the electronic unit 42 of the consumer 14. When connected to each other, the battery pack 100 provides the power supply for the consumer 14.

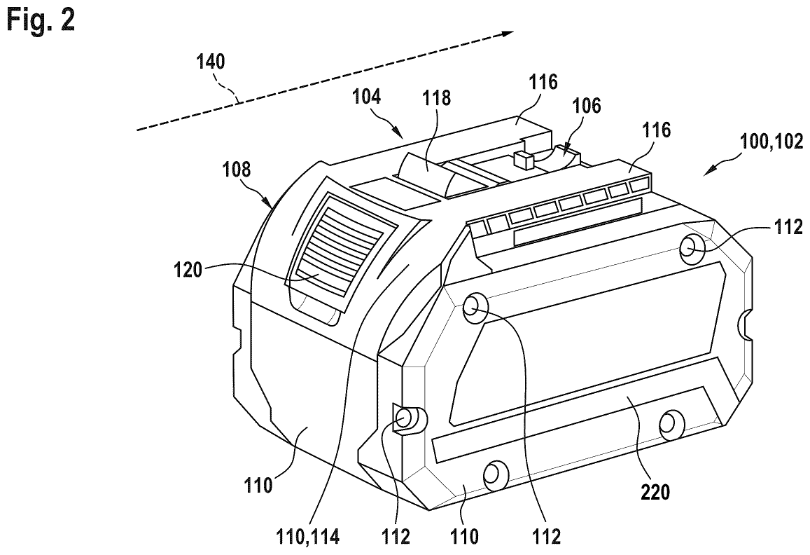

The battery pack 100 is shown in FIG. 2 in a perspective view. The battery pack 100 comprises a housing 108. The housing 108 of the battery pack 100 is exemplary made of a plastic, in particular a hard plastic. The housing 108 of the battery pack 100 comprises a plurality of housing portions 110 connected to each other in the form of screws, by way of connecting mechanism 112, as an example.

The upper housing portion 110 is formed as an interface housing portion 114 and comprises the electrical interface 106 and the mechanical interface 104 of the battery pack 100. The interface housing portion 114 is largely obstructed by the hand-held power tool 12 when connected to the hand-held power tool 12. The mechanical interface 104 comprises, by way of example, two guide elements 116 in the form of guide rails configured to guide in corresponding guide elements of the electrical consumer 14 during the connection process. The connection process occurs along a connection direction 140. The connection direction 140 is configured linearly as an example and extends straight along the guide element 116.

In addition, the battery pack 100 comprises a lock having a locking element 118. The locking element 118 is exemplary configured as a movable, in particular rotatable, locking element 118 and biased with a spring element (not shown) towards the locking position. The lock also includes an actuating element 120 that is configured to be manually actuatable. The actuating element 120 is also mounted, by way of example, in the housing 108 of the battery pack 100, in particular in the interface housing portion 114, in a linearly movable manner as an example.

The actuating element 120 is linearly movable in the housing 108 of the battery pack 100 and may be actuated by actuating along the connection direction 140 to unlock. The locking element 118 is coupled to the actuating element 120 such that the locking element 118 pivots into the housing 108 of the battery pack 100.

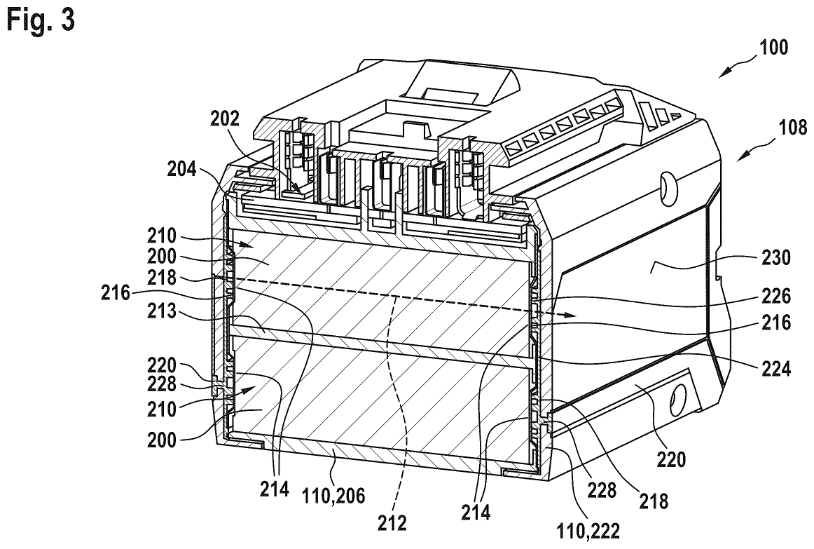

The battery pack 100 is shown in FIG. 3 in a perspective cross-section. The battery pack 100 has, by way of example, ten battery cells 200 arranged in the housing 108 of the battery pack 100. An electronic unit 202 is also arranged in the housing 108 of the battery pack 100. The electronic unit 202 comprises, by way of example, a printed circuit board 204 on which electrical components, such as light emitting diodes, power semiconductors, switches, temperature sensors, a computing unit, a storage unit, etc., are arranged.

The battery pack 100 comprises a cell holder 206 in which the battery cells 200 are housed. By way of example, the battery pack 100 comprises a single cell holder 206 that is formed in one-piece. The cell holder 206 partially forms an outer surface of the housing 108 and is thus also configured as a housing portion 110. The cell holder 206 has, by way of example, ten single cell receptacles 210 configured to hold individual battery cells 200. The single cell receptacles 210 are configured such that the battery cells 200 are substantially completely surrounded by a wall 213 of the cell holder 206 along their longitudinal extension 212 and preferably at least in regions abut them.

The battery cells 200 are housed in parallel with each other in the cell holder 206 and each have a cell pole 214 on their opposite sides. At the cell poles 214, the battery cells 200 are electrically connected to each other via cell connectors 216. The cell connectors 216 may be connected to the cell poles 214 in a material-locking manner, for example via a welding process or a soldering process. Alternatively, it is also contemplated that cell connectors 216 may be connected to battery cells 200 in a force-locking manner to facilitate replacement of battery cells 200. The cell connectors 216 are made of metal sheets, for example copper.

During the charging or discharging process, the battery cells 200 heat up, which, if the temperature is too high, can lead to limitations on the performance of the battery pack 100. To improve the heat dissipation outwardly, the battery pack 100 comprises a first thermal conductive element 218 and a second thermal conductive element 220 connected to each other.

The first thermal conductive element 218 is exemplary made of a plastic, in particular a thermoplastic elastomer, with a thermal conductivity in a range between 1 W/m*k and 10 W/m*K.

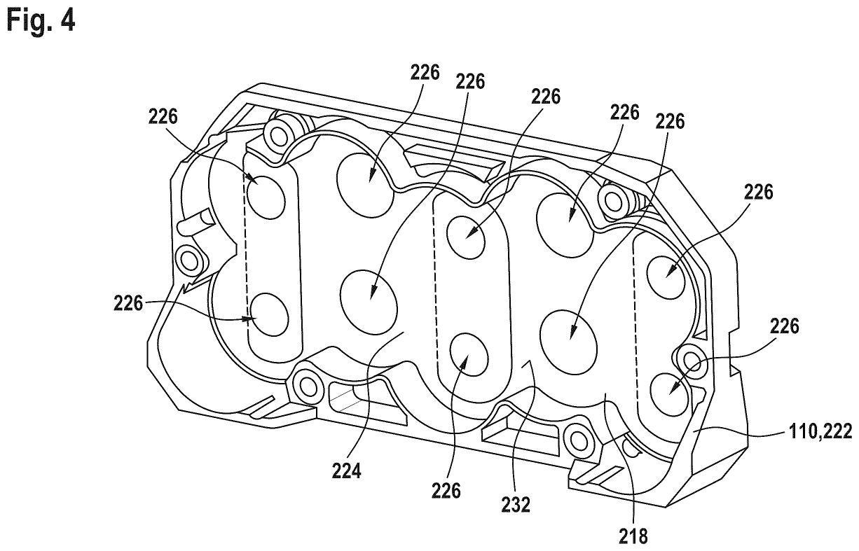

The battery pack 100, by way of example, comprises two first thermal conductive elements 218 each connected to a side housing portion 222. In particular, the first thermal conductive element 218 is arranged, by way of example, in the side housing portion 222, such that the first thermal conductive element 218 substantially completely covers an inner side 232 of the housing portion 110, as can be seen in FIG. 4. The first thermal conductive element 218, by way of example, has a base surface 224 having a first thickness and contact areas 226 having a second thickness, wherein the second thickness is formed by at least 50%, preferably by at least 100%, greater than the first thickness, as can be seen in FIG. 3. By way of example, the first thermal conductive element 218 has a corresponding contact area 226 per cell pole 214 and thus 10 contact areas 226.

The first thermal conductive element 218 is in thermal contact with the battery cells 200 via the cell connectors 216. The thermal contact is made by the first thermal conductive element 218, in particular the contact areas 226 of the first thermal conductive element 218, making contact with the cell connectors 216 above the cell poles 214. Advantageously, a very efficient heat transport can thereby be realized.

In particular, the base surface 224 connects all contact areas 226 of the first thermal conductive element 218, so that the heat is optimally distributed and/or balanced.

The second thermal conductive element 220 is arranged on an outer side 230 of the side housing portion 222. The second thermal conductive element 220 is connected to the first thermal conductive element 218 via a connection channel 228 in the form of a recess in the side housing portion 222. The recess extends substantially along the entire longitudinal extension of the battery pack 100, but shorter or multiple connection channels 228 would also be contemplated.

By way of example, the first thermal conductive element 218 and the second thermal conductive element 220 are formed in one piece, such that the first thermal conductive element 218 and the second thermal conductive element 220 are made of the same material. In particular, the side housing portion 222 is integrally formed with the first and second thermal conductive elements 218, 220 as a 2K injection molding part by over-molding the housing portion 110. However, a formation as an insert would also be conceivable.

An area occupying the second thermal conductive element 220 on the outer side 230 of the side housing portion 222 is, by way of example, smaller than an area surface of the first thermal conductive element 218 on the inner side 232 of the side housing portion 222.

What is claimed is:

1. A battery pack, comprising:
at least one housing configured to receive at least one battery cell,
a first thermal conductive element; and
a second thermal conductive element;
wherein the at least one housing includes at least one housing portion with a cell connector configured to electrically connect the at least one battery cell to the first thermal conductive element in thermal contact with the least one battery cell,
wherein the first thermal conductive element and the second thermal conductive element are arranged on different sides of the at least one housing, and
wherein the second thermal conductive element is connected to the first thermal conductive element.

2. The battery pack according to claim 1, wherein:
the at least one housing portion includes a connection channel in the form of a recess, and
the first thermal conductive element and/or the second thermal conductive element are arranged in the connection channel.

3. The battery pack according to claim 1, wherein the first thermal conductive element and the second thermal conductive element are formed in one piece.

4. The battery pack according to claim 1, wherein the housing portion is at least partially over-molded by the first thermal conductive element and/or the second thermal conductive element.

5. The battery pack according to claim 1, wherein the first thermal conductive element and/or the second thermal conductive element are made of a plastic.

6. The battery pack according to claim 1, wherein the first thermal conductive element and/or second thermal conductive element are made of a thermoplastic elastomer.

7. The battery pack according to claim 1, wherein a thermal conductivity of the first thermal conductive element and/or the second thermal conductive element is arranged in a range between 1 W/m*k and 10 W/m*K.

8. The battery pack according to claim 1, wherein the first thermal conductive element abuts directly against the cell connector.

9. The battery pack according to claim 1, wherein the first thermal conductive element substantially completely covers an inner side of the at least one housing portion.

10. The battery pack according to claim 1, wherein the second thermal conductive element has an area formed substantially equal to or smaller than an area of the first thermal conductive element.

11. The battery pack according to claim 1, wherein the second thermal conductive element has a wall thickness, which is in a range between 0.2 mm to 2.0 mm.

12. The battery pack according to any claim 1, wherein the second thermal conductive element has a hardness that is in a range between 10 Shore A and 90 Shore A.

13. The battery pack according to claim 1, wherein the battery pack is an exchangeable battery pack.

14. The battery pack according to claim 1, wherein the second thermal conductive element has a wall thickness, which is in a range between 0.5 mm to 1.5 mm.

15. The battery pack according to claim 1, wherein the second thermal conductive element has a wall thickness, which is in a range between 0.5 mm to 1 mm.

16. The battery pack according to claim 1, wherein the second thermal conductive element has a hardness that is in a range between 20 Shore A and 50 Shore A.
